(19) United States
(12) Patent Application Publication
(10) Pub. No.: US 2004/0184146 A1
(43) Pub. Date: Sep. 23, 2004

(54) Three-dimensional image display device, portable terminal device, and lenticular lens

(75) Inventors: Shin-ichi Uehara, Tokyo (JP); Nobuaki Takanashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/787,128

(22) Filed: Feb. 27, 2004

(30) Foreign Application Priority Data
Feb. 28, 2003 (JP) 2003-054677

(51) Int. Cl. G02B 27/22; G02B 27/26

(52) U.S. Cl. 359/462

(57) ABSTRACT

A three-dimensional image display device is provided with a liquid crystal display panel, where a plurality of pixels for the right eye displaying an image for the right eye and a plurality of pixels for the left eye displaying an image for the left eye are arrayed, and a lenticular lens that is arranged on a side of the liquid crystal display panel, which faces a viewer, and whose surface facing the liquid crystal display panel is flat and surface facing the viewer has a plurality of hog-backed cylindrical lenses formed thereon so as to be parallel with each other, in which the lens pitch of the cylindrical lenses of the lenticular lens is set to 0.2 mm or less.

### BACKGROUND OF THE INVENTION

1. Field of the Invention

The present invention relates to a three-dimensional image display device and a portable terminal device, which comprise an optical unit that essentially consists of a plurality of lenses such as a lenticular lens and a fly-eye lenses, and a lenticular lens, particularly to a three-dimensional image display device, a portable terminal device, and a lenticular lens, where striped patterns caused by a lens shape does not occur in a three-dimensional image that a viewer recognizes and whose display quality is superior.

2. Description of the Related Art

Conventionally, a display device capable of displaying three-dimensional images has been under study. Regarding binocular vision, Euclid who is a Greek mathematician considered in 280 B.C. that “Binocular vision is a sensation obtained when both right and left eyes simultaneously look at different images of a same object viewed from different directions’ (refer to a literature “Three-dimensional display” written by Chihiro Masuda and published by Sangyo Tosho K.K., p.1). Specifically, as a function of the three-dimensional image display device, it is necessary that images having parallax from each other be individually presented for both right and left eyes of the viewer.

Many three-dimensional image display methods are being studied as a method to specifically realize the function. The three-dimensional image display methods are largely divided into methods using eyeglasses and methods using no eyeglasses. Although the methods using eyeglasses are an anaglyph method using color difference, a polarized eyeglasses method using polarization, and the like, these methods essentially have to give viewers burdens of wearing eyeglasses, so that the study of the methods using no eyeglasses has been actively done in recent years.

The eyeglass-less methods are a lenticular lens method, a parallax barrier method, and the like. The parallax barrier method is a three-dimensional image display method invented by Berthier in 1896, and Ives proved the idea in 1903. FIG. 1 is an optical model diagram showing a method that displays the three-dimensional image by the parallax barrier method. As shown in FIG. 1, a parallax barrier 101 is a barrier (light shield) on which a large number of thin vertically striped openings, that is, slits 101a are formed. And the display panel 102 is arranged near one surface of the parallax barrier 101. Pixels 102a for the left eye and pixels 102b for the right eye are arrayed on the display panel 102 in a direction orthogonal to the longitudinal direction of the slits 101a. Further, a light source (not shown) is arranged near the other surface of the parallax barrier 101, that is, on the opposite side of the display panel 102.

A part of light emitted from the light source is blocked by the parallax barrier 101. On the other hand, light, which has passed the slits 101a without being blocked by the parallax barrier, transmitted the pixels 102a for the left eye and becomes a light fluxes 103a, or transmitted the pixels 102b for the right eye and becomes a light fluxes 103b. In doing so, the pixels 102a for the left eye and the pixels 102b for the right eye are arranged such that the light fluxes 103a having transmitted the pixels 102a for the left eye reaches the left eye 104a of the viewer and the light fluxes 103b having transmitted the pixels 102b for the right eye reaches the right eye 104b of the viewer. Thus, the light from the different pixels reaches the both eyes of the viewer, so that the viewer can recognize the image displayed on the display panel 102 as a three-dimensional image.

The above-described parallax barrier method, when it was invented at first, had a problem that the parallax barrier had been an eyesore and caused low visibility because it was arranged between the pixels and the eyes. However, with the achievement of liquid crystal display panels in recent years, it has become possible to arrange the parallax barrier on the rear side of the display panel, and the problem of visibility has been improved. Accordingly, study of the three-dimensional image display device of the parallax barrier method is actively studied.

Meanwhile, the lenticular lens method was invented around 1910 by Ives, et al. as described in the above-described literature (“Three-dimensional display” written by Chihiro Masuda and published by Sangyo Tosho K.K., p.1). FIG. 2 is a perspective view showing the lenticular lens, and FIG. 3 is an optical model diagram showing a three-dimensional image display method using the lenticular lens. As shown in FIG. 2, one surface of a lenticular lens 110 is in flat surface and hog-backed convex portions (cylindrical lenses) 111 extending in one direction are formed in plural numbers on the other surface such that their longitudinal directions become parallel with each other. Then, as shown in FIG. 3, a display panel 114, where pixels 112a for the left eye displaying an image for the left eye 113a and pixels 112b for the right eye displaying an image for the right eye 113b are alternately arrayed, is arranged on the focal plane of the lenticular lens 110. Thus, light emitted from the pixels 112a for the left eye and the pixels 112b for the right eye is distributed by the lenticular lens 110 into directions for the left eyes 113a or the right eye 113b. Accordingly, the light from the different pixels reaches the viewer's right and left eyes, which allows the viewer to recognize the three-dimensional image.

While the above-described parallax barrier method is a method where a barrier eliminates unnecessary light, the lenticular lens method is a method where the lens changes a traveling direction of light and which uses all light emitted from the light source, so that the brightness of a display screen does not reduce in principle. Therefore, the three-dimensional image display device of the lenticular lens method is expected to be applied to a portable device attached importance to high-brightness display and a low power consumption performance.

A display device using a lenticular lens where the lens pitch of cylindrical lenses is 0.2196 mm and 0.2197 mm and an average lens pitch is 0.21963 mm is suggested as the three-dimensional image display device of the lenticular lens method (Japanese Patent Laid-Open Publication No. 133892/1997).

Further, the three-dimensional image display devices using the parallax barrier method and the lenticular lens method are currently commercialized (Nikkei Electronics, issued on Jan. 6, 2003, No.838, pp.26-27). For example, the literature (Nikkei Electronics, issued on Jan. 6, 2003, No.838, pp.26-27) introduces a three-dimensional image display device of the lenticular lens method using a liquid crystal display panel of a diagonal size of 7 inches, which has a display dot number of 800 dots in a horizontal direction and 480 dots in a vertical direction. FIG. 4 is an optical model diagram showing a display method of a conventional three-dimensional image display device of the lenticular lens method, which is introduced in the literature (Nikkei Electronics, issued on Jan. 6, 2003, No.838, pp.26-27). As shown in FIG. 4, the three-dimensional image display device is a 5-viewpoint method where a lenticular lens 120 is arranged on an image display side of a liquid crystal display panel 121 and one cylindrical lens corresponds to every 5 dots for each dot of red (R), green (G), and blue (B) in the liquid crystal display panel 121. In the three-dimensional image display device of the 5-viewpoint method, a viewer can see five different images by changing a viewing direction to image.

Furthermore, the conventional three-dimensional image display device of the lenticular lens method, which is introduced in the literature (Nikkei Electronics, issued on Jan. 6, 2003, No.838, pp.26-27) is the one that displays a three-dimensional image when the distance between the lenticular lens 120 and the liquid crystal display panel 121 is 0.6 mm and displays a two-dimensional image when the distance is 1.2 mm. Generally, the pixel 122 of the liquid crystal display panel 121 consists of 3 dots of RGB and its length is approximately 0.192 mm. Therefore, the pitch of the lenticular lens used in the conventional three-dimensional image display device is calculated as approximately 0.32 mm.

However, the conventional three-dimensional image display device of the lenticular lens method has a problem that light and dark striped patterns occur in a display image to cause a reduction of display quality. The problem occurs not only in the devices using the lenticular lens but also in all three-dimensional image display devices using lenses such as fly-eye lenses having unevenness on the surface. Particularly, since lenses are arrayed in two-dimensionally in the fly-eye lenses, the light and dark striped patterns are crossed two-dimensionally, and light and dark granular patterns occur in the display image to reduce the display quality.

### SUMMARY OF THE INVENTION

The object of the present invention is to provide a three-dimensional image display device, a portable terminal device, and a lenticular lens, where the occurrence of striped patterns is prevented in a three-dimensional image that a viewer recognizes and the display quality is superior.

The three-dimensional image display device according to the present invention includes: a display panel which has a plurality of pixel sections each of which includes a pixel displaying an image for the left eye and a pixel displaying an image for the right eye, said pixel sections being provided periodically in a direction; and an optical unit that consists of a plurality of lenses that refract light emitted from the pixels, in which the optical unit refracts the light emitted from the pixels and emits the light in directions different from each other to make the light from different pixels incident to the right and left eyes of the viewer and to allow the viewer to recognize the three-dimensional image, and the lens pitch of the optical unit is 0.2 mm or less.

In the three-dimensional image display device of the present invention, the lens pitch of the optical unit is set to 0.2 mm or less. When the viewer holds the three-dimensional image display device in hand and views the three-dimensional image while he/she moves, the distance between the longest line segment out of line segments, which are parallel with a line segment connecting the pixels displaying an image for the left eye and the pixels displaying an image for the right eye, in a three-dimensional visible range from which the viewer can recognize the three-dimensional image, and the surface of the optical unit is approximately 350 mm. Then, by setting the lens pitch of the optical unit to 0.2 mm or less, the width of a light portion and a dark portion in the striped patterns that occur in the three-dimensional image is set no more than the resolution of the viewer, which prevents the viewer from recognizing the striped patterns in the three-dimensional image even when he/she holds the three-dimensional image display device in hand and views the three-dimensional image while he/she moves.

Another three-dimensional image display device according to the present invention includes: a display panel which has a plurality of pixel sections each of which includes a pixel displaying an image for the left eye and a pixel displaying an image for the right eye, said pixel sections being provided periodically in a direction; and an optical unit that consists of a plurality of lenses that refract light emitted from the pixels, in which the optical unit refracts the light emitted from the pixels and emits the light in directions different from each other to make the light from different pixels incident to the right and left eyes of the viewer and to allow the viewer to recognize the three-dimensional image, and when the distance between the longest line segment out of line segments, which are parallel with the line segment connecting the pixels displaying an image for the left eye and the pixels displaying an image for the right eye, in a three-dimensional visible range from which the viewer can recognize the three-dimensional image, and the surface of the optical unit is set to OD (mm) and the lens pitch of the optical unit is set to L (mm), the distance OD is 350 mm or less, and the distance OD and the lens pitch L satisfy the following expression 1.

### Expression 1

L≦2×OD×tan(1′)

In the present invention, by setting the lens pitch L to twice or less the product of the distance OD and the tangent of an angle of 1 minute, where the distance OD is one between the longest line segment out of line segments, which are parallel with the line segment connecting the pixels displaying an image for the left eye and the pixels displaying an image for the right eye, in a three-dimensional visible range, and the surface of the optical unit, the width of the light portion and the dark portion in the striped patterns that occur in the three-dimensional image is set no more than the resolution of the viewer when the distance between the viewer and the optical unit is 350 mm or less and the viewer's eyesight is 1.0. Thus, the viewer cannot recognize the striped patterns, and the reduction of a display image quality caused by using lenses having unevenness on surface is prevented.

Another three-dimensional image display device according to the present invention includes: a display panel which has a plurality of pixel sections each of which includes a pixel displaying an image for the left eye and a pixel displaying an image for the right eye, said pixel sections being provided periodically in a direction; and an optical unit that consists of a plurality of lenses that refract light emitted from the pixels, in which the optical unit refracts the light emitted from the pixels and emits the light in directions different from each other to make the light from different pixels incident to the right and left eyes of the viewer and to allow the viewer to recognize the three-dimensional image, and the lens pitch of the optical unit is 0.124 mm or less.

As described above, when the viewer holds the three-dimensional image display device in hand and views the three-dimensional image while he/she moves, the distance ND between a point in the three-dimensional visible range, where the distance from the surface of the optical unit is minimum, and the surface of the optical unit is approximately 213 mm. Consequently, in the present invention, by setting the lens pitch of the optical unit to 0.124 mm or less, the width of the light portion and the dark portion in the striped patterns that occur in the three-dimensional image can be set no more than the resolution of the viewer having eyesight of 1.0 in the entire three-dimensional visible range even when he/she holds the three-dimensional image display device in hand and views the three-dimensional image while he/she moves.

Another three-dimensional image display device according to the present invention includes: a display panel which has a plurality of pixel sections each of which includes a pixel displaying an image for the left eye and a pixel displaying an image for the right eye, said pixel sections being provided periodically in a direction; and an optical unit that consists of a plurality of lenses that refract light emitted from the pixels, in which the optical unit refracts the light emitted from the pixels and emits the light in directions different from each other to make the light from different pixels incident to the right and left eyes of the viewer and to allow the viewer to recognize the three-dimensional image, and when the distance between a point in a three-dimensional visible range, from which the viewer can recognize the three-dimensional image and whose distance from the surface of the optical unit becomes a minimum, and the surface of the optical unit is set to ND (mm) and the lens pitch of the optical unit is set to L (mm), the distance ND is 213 mm or less, and the distance ND and the lens pitch L satisfy the following expression 2.

### Expression 2

L≦2×ND×tan(1′)

In the present invention, by setting the lens pitch L to twice or less the product of the distance ND and the tangent of an angle of 1 minute, where the distance ND is one between the point in a three-dimensional visible range, where the distance from the surface of the optical unit becomes the minimum, and the surface of the optical unit, the width of the light portion and the dark portion in the striped patterns that occur in the three-dimensional image is set no more than the resolution of the viewer when the distance ND is 213 mm or less and the viewer's eyesight is 1.0.

It is preferable that the pixel sections consist of two types of pixels that are the pixels for the right eye and the pixels for the left eye. Accordingly, when the pixels for the right eye and the pixels for the left eye are allowed to display different images, the viewer views the different images by his/her right and left eyes, and the viewer can recognize the three-dimensional image. Further, by allowing the pixels for the right eye and the pixels for the left eye to display a same image, the viewer can also recognize a two-dimensional image.

Further, the lenticular lens or the fly-eye lens can be used as the optical unit, for example. When the lenticular lens is used for the optical unit, the three-dimensional visible range in a longitudinal direction of the lenticular lens can be widened. On the other hand, when the fly-eye lens is used for the optical unit, it can display different images in four directions horizontally and vertically. For example, the viewer views different three-dimensional images by changing an observing position in a vertical direction, which improves 3-D feeling.

Furthermore, the display panel is a liquid crystal display panel, for example. This makes it possible to manufacture various sizes of three-dimensional image display devices ranging from a small display device such as a portable device to a large display device which a plurality of viewers view at the same time.

The portable terminal device according to the present invention has the above-described three-dimensional image display device. In the present invention, the viewer can view a high-quality three-dimensional image even on the portable terminal device by mounting the above-described three-dimensional image display device therein.

Further, the portable terminal device is a cellular phone, a PDA (Personal Digital Assistance), a game machine, a digital camera, and a digital video camera, for example. By mounting the above-described three-dimensional image display device in these portable devices, the viewer can readily enjoy the high-quality three-dimensional image.

The lenticular lens according to the present invention is a lenticular lens where a plurality of cylindrical lenses are arrayed such that their longitudinal directions become parallel with each other, and the lens pitch of the cylindrical lenses is 0.124 mm or less. In the present invention, by setting the lens pitch of the cylindrical lenses on the lenticular lens to 0.124 mm or less, it is possible to allow the viewer to view the three-dimensional image without letting him/her recognize the striped patterns on the entire three-dimensional visible range when the lens is used as the optical unit of the three-dimensional image display, device.

According to the present invention, in the three-dimensional image display device having the optical unit that essentially consists of a plurality of lenses such as a lenticular lens and a fly-eye lens, the lens pitch of a plurality of the lenses is set to 0.2 mm or less to prevent the viewer from recognizing the striped patterns that occurs by the reflection of exterior light at lens surface, and the display quality of the three-dimensional image that the viewer views is improved.

### BRIEF DESCRIPTION OF THE DRAWINGS

FIG. 1 is an optical model diagram showing a method that displays a three-dimensional image by a parallax barrier method;

FIG. 2 is a perspective view showing the lenticular lens;

FIG. 3 is an optical model diagram showing a three-dimensional image display method using a lenticular lens;

FIG. 4 is an optical model diagram showing a display method of a conventional three-dimensional image display device of the lenticular lens method, which is introduced in the literature (Nikkei Electronics, issued on Jan. 6, 2003, No.838, pp.26-27);

FIG. 5A is a typical view showing light reflection at lens surface when exterior light is diffused light, and

FIG. 5B is a typical view showing light reflection at lens surface when exterior light is parallel light;

FIG. 6 is a perspective view showing a three-dimensional image display device according to the embodiments of the present invention;

FIG. 7 is an optical model diagram showing an optical arrangement of a display panel, an optical unit, and a viewer in the three-dimensional image display device according to the embodiments of the present invention;

FIG. 8 is a perspective view showing a look where a viewer views an image displayed on the three-dimensional image display device according to the embodiments of the present invention while moving the device;

FIG. 9 is a perspective view showing a cellular phone that mounts the three-dimensional image display device of this embodiment therein; and

FIG. 10 is a perspective view showing a fly-eye lens.

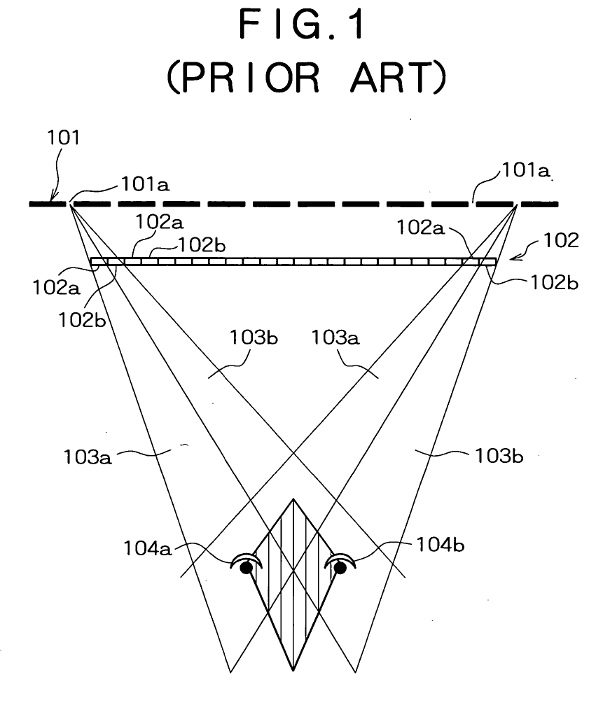

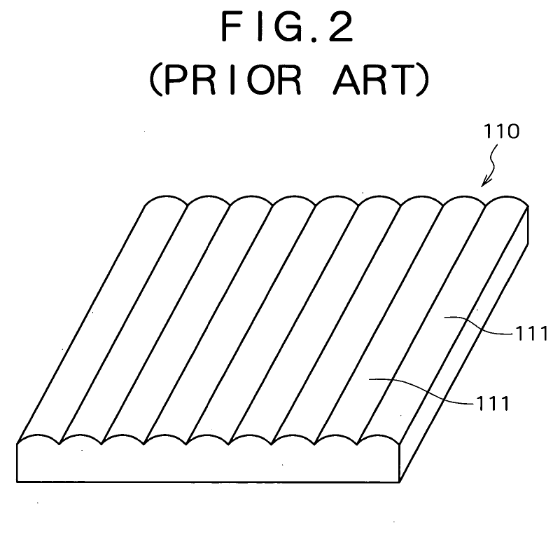

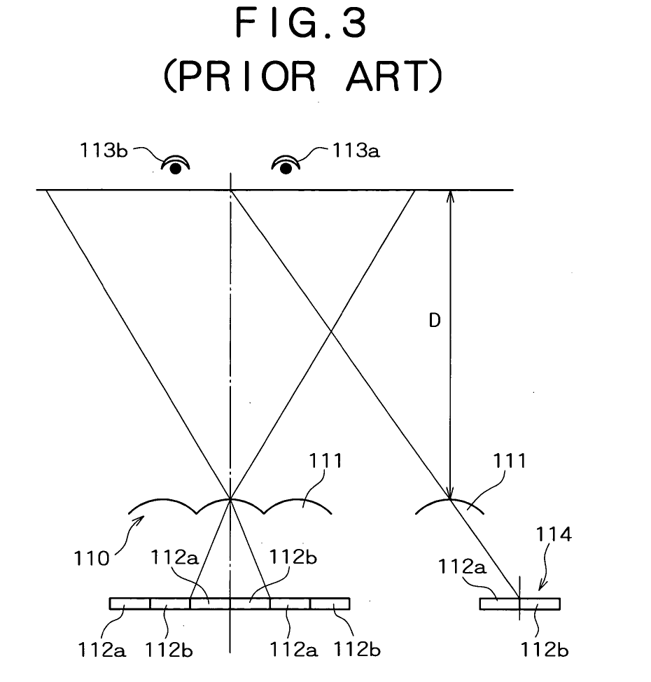

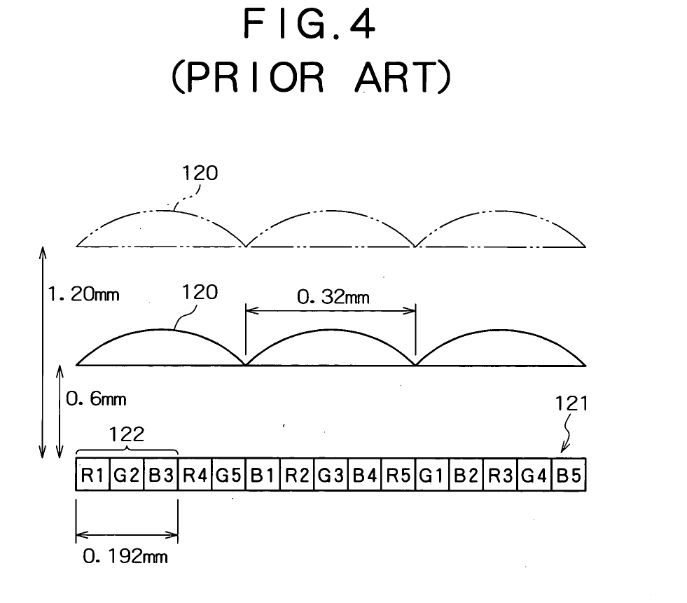

### DETAILED DESCRIPTION OF THE PREFERRED EMBODIMENTS

Since the striped patterns at stake in the conventional three-dimensional image display device of the lenticular lens method are viewed while overlaid on a display image, the quality of the display image recognized by a viewer is reduced and consequently becomes an eyesore in image observation. Then, the inventors of the present invention have committed themselves into study regarding the lens pitch L of the cylindrical lenses of the lenticular lens and the visibility of the striped patterns that appear on the three-dimensional image, and found out that the striped patterns had been viewed when the exterior light was reflected at the lens surface.

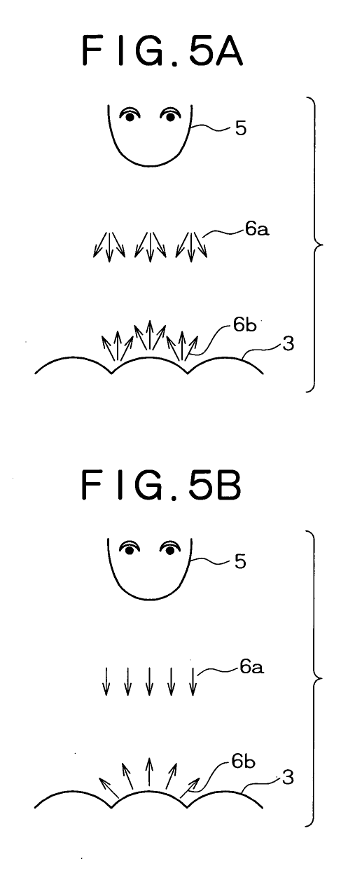

The combined width of the light portion and the dark portion of the striped patterns is equal to the lens pitch L of the cylindrical lenses, and each width of the light portion and the dark portion varies depending on the characteristic of the exterior light. FIG. 5A is the typical view showing light reflection at the lens surface when the exterior light is diffused light, and FIG. 5B is the typical view showing light reflection at the lens surface when the exterior light is parallel light. As shown in FIG. 5A, when the exterior light is the diffused light, exterior light 6a from various directions reflects at the surface of a lenticular lens 2, so that reflected light incident to a viewer 5 does not depend on the position at the surface of the lenticular lens 2.

On the other hand, as shown in FIG. 5B, when the exterior light 6a is the parallel light, the reflecting directions are different depending on the position at the surface of the lenticular lens 2, and light reflected at a particular position is made incident to the viewer 5 and light reflected at other positions is not made incident to the viewer 5. Thus, the viewer recognizes the light and dark striped patterns in the three-dimensional image, which correspond to the shape of the lens surface. Actually, the flux distribution characteristic of the exterior light depends on environment where the lens is used. For example, the light is the parallel light under direct sunlight and the diffused light in a room of indirect lighting. Additionally, it is known that the light has a characteristic by the mixture of the parallel light and the diffused light near direct fluorescent lighting. The flux distribution characteristic of the exterior light is different depending on the environment; each width of the light portion and the dark portion of the striped patterns that appear on the three-dimensional image depends on the environment where the lens is used.

Further, the combined width of the light portion and the dark portion is equivalent to the lens pitch L of cylindrical lenses 3 of the lenticular lens 2 as described above, and always fixed. For this reason, when the width of the light portion expands due to the flux distribution characteristic of the exterior light 6a, the width of the dark portion reduces, and on the contrary, the width of the light portion reduces when the width of the dark portion expands. In such a case, since the portion whose width has reduced is hard to recognize, it cannot be identified as the striped pattern. Therefore, when the light portion and the dark portion have the same width, that is, when each of the light portion and the dark portion has a width that is (½) the lens pitch, the striped patterns are viewed most clearly. To prevent the viewer from recognizing the striped patterns, it is necessary to set either width of the light portion or the dark portion to the resolution of the viewer's eyesight or more. The relationship between the viewer's eyesight and a minimum viewing angle that the viewer can identify is given by the following expression 3.

### Expression 3

Eyesight=1/minimum viewing angle (minutes)

For example, supposing the viewer's eyesight is 1.0 that is general eyesight, the minimum viewing angle of the viewer is 1 minute according to the expression 3. Further, when the display panel is used, where pixel sections including the pixels displaying an image for the left eye and the pixels displaying an image for the right eye are arrayed periodically in plural numbers, and when the distance between the longest line segment out of line segments, which are parallel with the line segment connecting the pixels displaying the image for the left eye and the pixels displaying the image for the right eye, in the three-dimensional visible range from which the viewer can recognize the three-dimensional image, and the surface of the optical unit is set to an optimal distance for the viewer to recognize the three-dimensional image, that is, an optimal observation distance OD (mm), and the optimal observation distance OD is 350 mm or less, the viewer's resolution is equivalent to the product of the optimal observation distance OD and the tangent of the angle of 1 minute. Therefore, when the optimal observation distance OD is 350 mm or less, the viewer cannot recognize the striped patterns by setting either width of the light portion or the dark portion to this value or less.

As described above, it is when the widths of the light portion and the dark portion of the stripe are equal and each width is (½) the lens pitch that the striped patterns are viewed most clearly. Then, in the present invention, the lens pitch L (mm) of the cylindrical lenses 3 is set to twice or less the product of the optimal observation distance OD and the tangent of the angle of 1 minute. Thus, since the viewer cannot recognize the striped patterns on the three-dimensional image, which occurs due to the reflection of the exterior light at the surface of the lenticular lens 2, the display quality of the three-dimensional image that the viewer see is improved comparing to that of a conventional three-dimensional image display device.

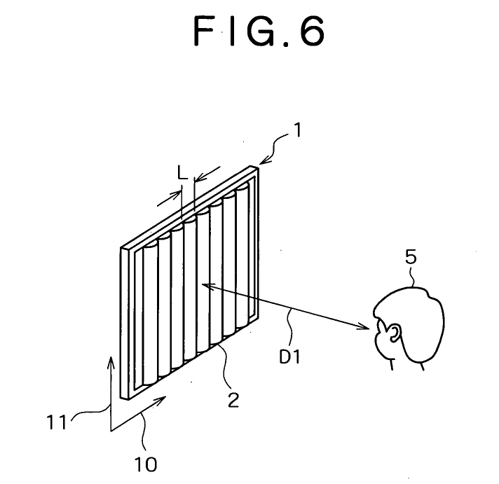

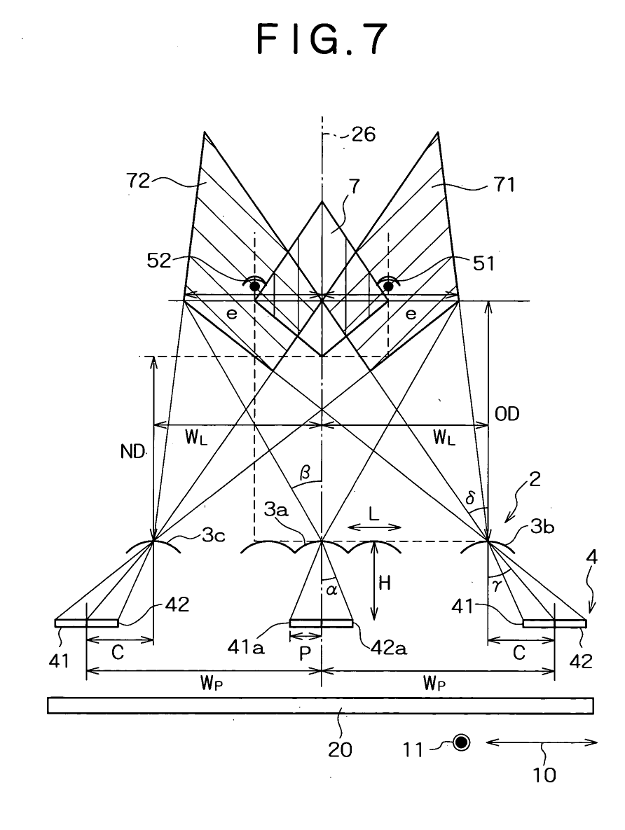

In the following, the three-dimensional image display device according to the embodiments of the present invention will be described with reference to the attached drawings. FIG. 6 is the perspective view showing the three-dimensional image display device according to the embodiments of the present invention. And, FIG. 7 is the optical model diagram showing the optical arrangement of the display panel, the optical unit, and the viewer in the three-dimensional image display device according to the embodiments of the present invention. As shown in FIGS. 6 and 7, a transmissive liquid crystal display panel 4 is used as the display panel in a three-dimensional image display device 1 of this embodiment, and the lenticular lens 2 that is the optical unit is arranged on the surface of the liquid crystal display panel 4, which faces the viewer 5.

On the liquid crystal display panel 4 that is the display panel of the three-dimensional image display device 1 of this embodiment, a plurality of pixels 42 for the right eye displaying an image for the right eye 52 and a plurality of pixels 41 for the left eye displaying an image for the left eye 51 are alternately arrayed along a horizontal direction 10, and the pixels 42 for the right eye and the pixels 41 for the left eye are arrayed in a vertical direction 11. Each of pixels 42 for the right eye and pixels 41 for the left eye has a sub-pixel for red, a sub-pixel for green and a sub-pixel for blue. Further, a light source 20 is arranged on the rear surface of the pixels 42 for the right eye and the pixels 41 for the left eye. Moreover, a display plane of the liquid crystal display panel 4 is a plane including the horizontal direction 10 and the vertical direction 11, and the horizontal direction 10 and the vertical direction 11 are orthogonal to each other.

In the lenticular lens 2, which is the optical unit of the three-dimensional image display device 1 of this embodiment, a side facing the display panel is in a flat surface and a plurality of hog-backed lenses (cylindrical lenses) 3 are formed so as to be parallel with each other on the surface facing the viewer 5. The lenticular lens 2 is arranged such that the longitudinal direction of the cylindrical lenses 3 becomes parallel with the vertical direction 11 of the liquid crystal display panel 4, and one cylindrical lens 3 corresponds to a row of pairs of pixels arrayed in the vertical direction 11, where each pair consists of the pixel 41 for the left eye and the pixel 42 for the right eye adjacent to each other. Furthermore, the lens pitch L (mm) of the cylindrical lenses 3 in the three-dimensional image display device 1 of this embodiment is twice or less the product of the optimal observation distance OD and the tangent of the angle of 1 minute.

In the three-dimensional image display device 1 of this embodiment, the lens pitch L is set to twice or less the product of the optimal observation distance OD and the tangent of the angle of 1 minute, it is possible to set the width of the light portion and the dark portion of the striped patterns that occur on the three-dimensional image to no more than the resolution of the viewer 5 having eyesight of 1.0 when the optimal observation distance OD is 350 mm or less. This prevents the viewer 5 from recognizing the striped patterns, and three-dimensional image display is achieved without reducing the display quality even when a lens such as the lenticular lens 2 whose surface is not flat is used.

Then, the definition of the optimal observation distance OD in this embodiment will be described. As shown in FIG. 7, in the three-dimensional image display device 1 of this embodiment, the viewer 5 can recognize the three-dimensional image when the right eye 52 of the viewer 5 exists in a right eye area 72 and the left eye 51 exists in a left eye area 71. However, because the interval between the right eye 52 and the left eye 51 is fixed and it is impossible to arrange the right and left eyes in all of the areas, so that the arrangement is limited within a range of the interval between the right eye 52 and the left eye 51. Specifically, the viewer can recognize the three-dimensional image when the center of the interval between the right eye 52 and the left eye 51 exists in a three-dimensional visible range 7. When the center of the interval between the right eye 52 and the left eye 51 positions on a diagonal line in the horizontal direction 10 in the three-dimensional visible range 7, an observation region in the horizontal direction 10 becomes maximum, so that this position is the most ideal observing position. Consequently, in this embodiment, the distance between the diagonal line in the horizontal direction 10 in the three-dimensional visible range 7 and the surface of the lenticular lens 2 is defined as the optimal observation distance OD.

Further, as shown in FIG. 7, in the three-dimensional image display device 1 of the present invention, the thickness and the refraction index of the lenticular lens 2 are defined as H and n, respectively, and the lens pitch of the cylindrical lenses 3 is defined as L. The refraction index n of the lenticular lens 2 is determined by a material to be used. Further, each pitch of the pixels 41 for the left eye and the pixels 42 for the right eye, which are arranged on the liquid crystal display panel 4 as the display panel, is defined as P. Generally, since it is often the case that the lenticular lens 2 is designed for the display panel, the pixel pitch P is treated as a constant. Further, an image of one pixel projected on the optimal observation distance OD through the lenticular lens 2 is defined as an expanded projection width e. Note that the expanded projection width e is regarded as the distance between the right eye 52 and the left eye 51 in this embodiment. Supposing the distance between the center of a cylindrical lens 3a located at the center in the horizontal direction 10 of the lenticular lens 2 and the center of a cylindrical lens 3c located at the end of the lenticular lens 2 is W_{L}, and the distance between the central position of a pixel pair that consists of a pixel 41a for the left eye and a pixel 42a for the right eye, which is located at the center of the liquid crystal display panel 4, and the central position of a pixel pair located at the end of the liquid crystal display panel 4 is W_{P}, the constant is expressed by the following expressions 4 to 9 by Snell's law and the geometrical relationship.

$$\begin{matrix}n = \frac{sin β}{sin α} & ( Expression 4 ) \\ n = \frac{sin δ}{sin γ} & ( Expression 5 )\end{matrix}$$

### Expression 6

e=OD×tanβ

### Expression 7

P=H×tanα

$$\begin{matrix}H = \frac{C}{tan δ} & ( Expression 8 ) \\ OD = \frac{{W}_{L}}{tan δ} & ( Expression 9 )\end{matrix}$$

In the expressions 4 to 9, α and β show an incident angle and an output angle of light at the cylindrical lens 3a located at the center of the lenticular lens 2, and γ and δ show the incident angle and the output angle of light at the cylindrical lens 3b located at the end of the lenticular lens 2 (refer to FIG. 7). Further, C in the expression 8 is a difference between the distance W_{L} and the distance W_{P}, which is expressed by the following expression 10.

### Expression 10

W_{P}−W_{L}=C

In the expression 10, supposing the number of pixels included in the region of the distance W_{P}, is 2 m, the following expressions 11 and 12 hold.

### Expression 11

Wₚ=2mP

### Expression 12

W_{L}=mL

Therefore, the optimal observation distance OD in the three-dimensional image display device 1 of this embodiment can be found by the following expression 13.

### Expression 13

$$OD = \frac{L \times H}{2 P - L}$$

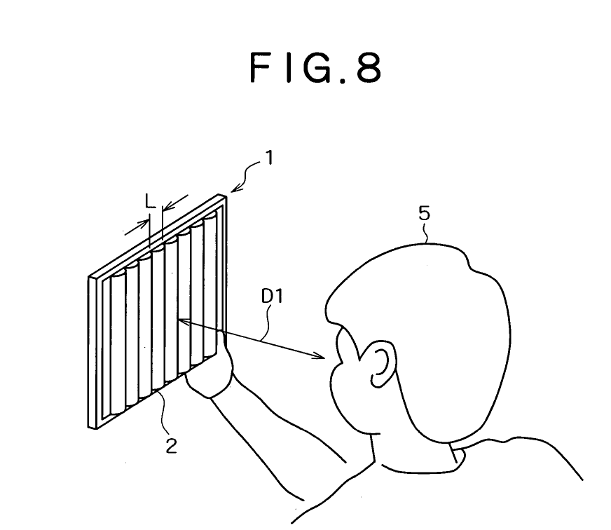

Next, description will be made for a case where the viewer holds the three-dimensional image display device 1 of this embodiment by hand and views the image while he/she moves. FIG. 8 is the perspective view showing the appearance. When the viewer 5 holds the three-dimensional image display device 1 of this embodiment, which is a portable device, for example, by hand and views the three-dimensional image as he/she moves, the optimal observation distance OD is approximately 350 mm. Then, in the three-dimensional image display device 1 of this embodiment, the lens pitch L is set to 0.2 mm or less. Thus, the viewer 5 can view a high-quality three-dimensional image without recognizing the striped patterns on the three-dimensional image even when holding the three-dimensional image display device 1 by hand and observing the three-dimensional image as he/she moves.

Furthermore, in the three-dimensional image display device 1 of this embodiment, binocular vision is achieved when the center of the both eyes of the viewer 5 is located in the three-dimensional visible range 7, and a position from which binocular vision can be achieved exists even in a region apart from the display panel 3 shown in FIG. 7 by a distance ND (mm). Meanwhile, the distance between a point, whose distance from the cylindrical lenses 3 becomes minimum in a region binocular vision is achieved (three-dimensional visible range 7), and the cylindrical lenses 3 is defined as the shortest observation distance ND, in this embodiment. The shortest observation distance ND is calculated, for example, by finding the distance of a point, which is remote from an optical system center by (e/2) in a direction of the right eye area 72 for light emitted from the right end of the pixel 42 for the right eye located at the far right of the display panel 3, from display pixels. Thus, the following expression 14 holds from the geometrical relationship.

$$( {W}_{L} + e ) \text{:} OD = ( {W}_{L} + \frac{e}{2} ) \text{:} ND \qquad ( Expression 14 )$$

Consequently, the shortest observation distance ND is found by the following expression 15.

$$ND = \frac{OD \times ( {W}_{L} + \frac{e}{2} )}{( {W}_{L} + e )} \qquad ( Expression 15 )$$

In the three-dimensional image display device 1 of this embodiment, by setting the lens pitch L of the cylindrical lenses 3 to twice or less the product of the shortest observation distance ND and the tangent of the angle of 1 minute, the width of the light portion and the dark portion in the striped patterns that occur in the three-dimensional image can be set no more than the resolution of the viewer having eyesight of 1.0 in the entire three-dimensional visible range when the shortest observation distance ND is 213 mm or less.

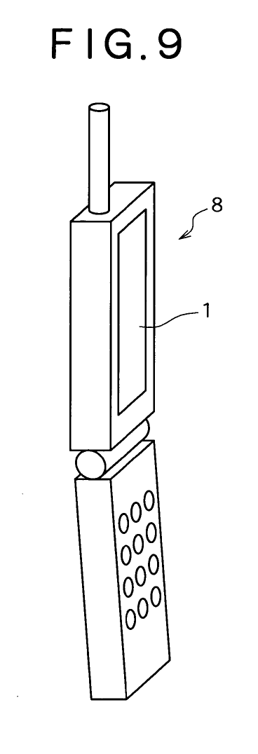

Next, a specific example of the shortest observation distance ND will be examined. FIG. 9 is the perspective view showing a cellular phone that mounts the three-dimensional image display device of this embodiment therein. For example, when the three-dimensional image display device 1 of this embodiment is mounted in a cellular phone 8 as shown in FIG. 9, a horizontal width of a display area in a display device having the diagonal size of 2.2 inches, which is used in regular cellular phones, is 36 mm and an approximate value of W_{L} is set to 18 mm. Further, supposing the optimal observation distance OD is set to 350 mm, from which the viewer can view the three-dimensional image holding the cellular phone 8 by hand while he/she moves, and the expanded projection width e is set to 65 mm, the shortest observation distance ND is calculated as 213 mm from the expression 15. Moreover, the lens pitch by which the viewer is prevented from viewing the striped patterns at the shortest observation distance ND is calculated as 0.124 mm from the expression 1. In other words, by setting the lens pitch to 0.124 mm or less, the viewer can view the three-dimensional image without recognizing the striped patterns in the entire three-dimensional visible range.

Then, the operation of the three-dimensional image display device 1 of this embodiment will be described. In the three-dimensional image display device 1 of this embodiment, the lenticular lens 2 having the above-described cylindrical lenses 3 changes the traveling direction of the light emitted from each pixel of the liquid crystal display panel 4, and the light emitted from the pixels 42 for the right eye is made incident to the right eye 52 of the viewer 5 and the light emitted form the pixel 41 for the left eye is made incident to the left eye 51. As a result, the light from the different pixels reaches to the right and the left eyes of the viewer 5, and the viewer 5 recognizes an image displayed on the liquid crystal display panel 4 as the three-dimensional image.

Furthermore, the three-dimensional image display device 1 of this embodiment can be used in various kinds of portable terminal devices such as the PDA, the game machine, the digital camera, and the digital video camera, other than the above-described cellular phone. In the portable terminal device mounting the three-dimensional image display device 1 of this embodiment therein, high-quality three-dimensional image is displayed without reducing the brightness comparing to a conventional portable terminal device mounting a display device that displays a two-dimensional image.

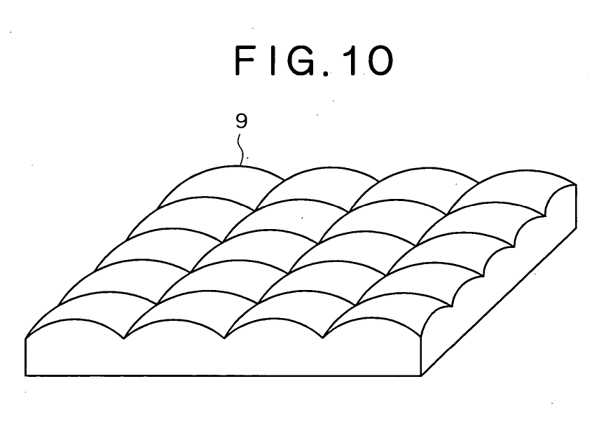

Although the case where the lenticular lens 2 was used has been described in this embodiment, the present invention is not limited to this, and the fly-eye lens where regular lenses are arrayed in a matrix state, or the like can be used as well. FIG. 10 is the perspective view showing the fly-eye lens. By using a fly-eye lens 9 shown in FIG. 10 as the optical unit, images different in four directions horizontally and vertically are displayed. Accordingly, the viewer can view different three-dimensional images by changing the observing position in the vertical direction, for example, which improves 3-D feeling.

Additionally, although the transmissive liquid crystal display panel was used as the display panel in the three-dimensional image display device of this embodiment, the present invention is not limited to this. A reflective liquid crystal display panel, a semi-transmissive liquid crystal display panel where each pixel is provided with a transmissive region and a reflective region, or a VE (visible everywhere) transflective liquid crystal display panel may be used. Further, the drive method of the liquid crystal display panel may be either an active matrix type such as a TFT (Thin Film Transistor) type and a TFD (Thin Film Diode) type, or a passive matrix type such as an STN (Super Twisted Nematic liquid crystal) type. Moreover, as the display panel, a display panel other than the liquid crystal display panel, which is an organic electro luminescence display panel, a plasma display panel, a CRT (Cathode-Ray Tube) display panel, an LED (Light Emitting Diode) display panel, a field emission display panel, or a PALC (Plasma Address Liquid Crystal) display panel, for example, may be used.

What is claimed is:

1. A three-dimensional image display device, comprising:
a display panel which has a plurality of pixel sections each of which included a pixel displaying an image for the left eye and a pixel displaying an image for the right eye, said pixel sections being provided periodically in a direction; and
an optical unit that consists of a plurality of lenses that refract light emitted from said pixels,
wherein said optical unit refracts the light emitted from said pixels and emits the light in directions different from each other to make the light from different pixels incident to the right and left eyes of a viewer and to allow said viewer to recognize a three-dimensional image, and the lens pitch of said optical unit is 0.2 mm or less.

2. A three-dimensional image display device, comprising:
a display panel which has a plurality of pixel sections each of which includes a pixel displaying an image for the left eye and a pixel displaying an image for the right eye, said pixel sections being provided periodically in a direction; and
an optical unit that consists of a plurality of lenses that refract light emitted from said pixels,
wherein said optical unit refracts the light emitted from said pixels and emits the light in directions different from each other to make the light from different pixels incident to the right and left eyes of a viewer and to allow said viewer to recognize a three-dimensional image, and when the distance between the longest line segment out of line segments, which are parallel with the line segment connecting the pixels displaying said image for the left eye and the pixels displaying said image for the right eye, in a three-dimensional visible range from which said viewer can recognize the three-dimensional image, and the surface of said optical unit is set to OD (mm) and the lens pitch of said optical unit is set to L (mm), said distance OD is 350 mm or less, and said distance OD and said lens pitch L satisfy the following expression.
L<2×OD×tan(1′)

3. A three-dimensional image display device, comprising:
a display panel which has a plurality of pixel sections each of which includes a pixel displaying an image for the left eye and a pixel displaying an image for the right eye, said pixel sections being provided periodically in a direction; and
an optical unit that consists of a plurality of lenses that refract light emitted from said pixels,
wherein said optical unit refracts the light emitted from said pixels and emits the light in directions different from each other to make the light from different pixels incident to the right and left eyes of a viewer and to allow said viewer to recognize a three-dimensional image, and the lens pitch of said optical unit is 0.124 mm or less.

4. A three-dimensional image display device, comprising:
a display panel which has a plurality of pixel sections each of which includes a pixel displaying an image for the left eye and a pixel displaying an image for the right eye, said pixel sections being provided periodically in a direction; and
an optical unit that consists of a plurality of lenses that refract light emitted from said pixels,
wherein said optical unit refracts the light emitted from said pixels and emits the light in directions different from each other to make the light from different pixels incident to the right and left eyes of a viewer and to allow said viewer to recognize a three-dimensional image, and when the distance between a point in a three-dimensional visible range, from which said viewer can recognize the three-dimensional image and whose distance from the surface of said optical unit becomes a minimum, and the surface of said optical unit is set to ND (mm) and the lens pitch of said optical unit is set to L (mm), said distance ND is 213 mm or less, and said distance ND and said lens pitch L satisfy the following expression.
L<2×ND×tan(1′)

5. The three-dimensional image display device according claims 1, wherein said pixel sections consist of two types of pixels that are the pixels for the right eye and the pixel for the left eye.

6. The three-dimensional image display device according to claims 1, wherein said optical unit is a lenticular lens.

7. The three-dimensional image display device according to claims 1, wherein said optical unit is a fly-eye lens.

8. The three-dimensional image display device according to claims 1, wherein said display panel is a liquid crystal display panel.

9. The three-dimensional image display device according to claims 2, wherein said pixel sections consist of two types of pixels that are the pixels for the right eye and the pixel for the left eye.

10. The three-dimensional image display device according to claims 2, wherein said optical unit is a lenticular lens.

11. The three-dimensional image display device according to claims 2, wherein said optical unit is a fly-eye lens.

12. The three-dimensional image display device according to claims 2, wherein said display panel is a liquid crystal display panel.

13. The three-dimensional image display device according to claims 3, wherein said pixel sections consist of two types of pixels that are the pixels for the right eye and the pixel for the left eye.

14. The three-dimensional image display device according to claims 3, wherein said optical unit is a lenticular lens.

15. The three-dimensional image display device according to claims 3, wherein said optical unit is a fly-eye lens.

16. The three-dimensional image display device according to claims 3, wherein said display panel is a liquid crystal display panel.

17. The three-dimensional image display device according to claims 4, wherein said pixel sections consist of two types of pixels that are the pixels for the right eye and the pixel for the left eye.

18. The three-dimensional image display device according to claims 4, wherein said optical unit is a lenticular lens.

19. The three-dimensional image display device according to claims 4, wherein said optical unit is a fly-eye lens.

20. The three-dimensional image display device according to claims 4, wherein said display panel is a liquid crystal display panel.

21. A portable terminal device, comprising the three-dimensional image display device according to claims 1.

22. A portable terminal device, comprising the three-dimensional image display device according to claims 2.

23. A portable terminal device, comprising the three-dimensional image display device according to claims 3.

24. A portable terminal device, comprising the three-dimensional image display device according to claims 4.

25. The portable terminal device according to claim 21, wherein said device is any one of a cellular phone, a personal information terminal, a game machine, a digital camera, and a digital video camera.

26. The portable terminal device according to claim 22, wherein said device is any one of a cellular phone, a personal information terminal, a game machine, a digital camera, and a digital video camera.

27. The portable terminal device according to claim 23, wherein said device is any one of a cellular phone, a personal information terminal, a game machine, a digital camera, and a digital video camera.

28. The portable terminal device according to claim 24, wherein said device is any one of a cellular phone, a personal information terminal, a game machine, a digital camera, and a digital video camera.

29. A lenticular lens where a plurality of cylindrical lenses are arrayed such that longitudinal directions thereof are parallel with each other, wherein the lens pitch of said cylindrical lenses is 0.124 mm or less.
